(19) United States
(12) Patent Application Publication
(10) Pub. No.: US 2025/0030489 A1
(43) Pub. Date: Jan. 23, 2025

(54) REDUCTION OF INTERFERENCE CAUSED BY DOWNLINK AGGRESSORS

(71) Applicant: Telefonaktiebolaget LM Ericsson (publ), Stockholm (SE)

(72) Inventors: Mark Wyville, Ontario (CA); Pierre-Andre Laporte, Gatineau (CA)

(21) Appl. No.: 18/716,073

(22) PCT Filed: Dec. 3, 2021
(86) PCT No.: PCT/IB2021/000838

§ 371 Date: Jun. 3, 2024

(51) Int. Cl. H04B 15/04; H04B 1/04; H04W 52/14

(52) U.S. Cl. CPC H04B 15/04; H04B 1/0475; H04W 52/143

(57) ABSTRACT

Methods and systems are described for reducing interference on radio units from passive intermodulation (PIM) distortion. Base station radio units can have multiple antennas, each receiving and sending communications over various frequencies. Embodiments under the present disclosure can identify the source of PIM and then reduce power of the aggressor downlink carriers on the impacted antennas. This can reduce the PIM that desensitizes the uplink receivers.

### TECHNICAL FIELD

The present disclosure is directed to reduction of interference in radio devices.

### BACKGROUND

A transmitter that simultaneously transmits and receives has the potential to be impacted by self-generated intermodulation distortion. For example, an FDD (frequency division duplex) radio could generate passive intermodulation (PIM) distortion in the filter, antenna, on the outer mechanics of the radio, or any other place where the transmit signals are present. The receiver's uplink channels can be desensitized if there is some overlap with the frequency spectrum of this intermodulation distortion. Radios with a large number of physical antenna ports can also be impacted by PIM.

### SUMMARY

One embodiment under the present disclosure comprises a method performed by a radio unit for mitigating interference in an uplink channel of the radio unit. The method can include detecting an interference level in each one of a plurality of antenna branches of the radio unit, and selecting one or more of the plurality of branches based on the detecting. Further steps include identifying one or more uplink channels on the selected branches that are impacted by interference, based at least in part on the detected interference level, each of the one or more identified uplink channels being associated with one or more downlink carriers. The method also includes is reducing downlink power on at least one of the one or more downlink carriers.

Another embodiment can comprise a method for identifying and mitigating interference within a radio unit. Steps can include detecting one or more levels of interference on a plurality of uplink channels comprising one or more antenna branches of the base station. Further steps include identifying one or more of the plurality of uplink channels that are impacted by interference, each of the one or more uplink channels being associated with one or more downlink carriers and reducing downlink power on at least one of the one or more downlink carriers.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

The foregoing has outlined rather broadly the features and technical advantages of the present disclosure in order that the detailed description that follows may be better understood. Additional features and advantages of the disclosure will be described hereinafter which form the subject of the claims. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a diagram of a radio unit embodiment under the present disclosure;

FIG. 2 is a process flow diagram of a method embodiment under the present disclosure;

FIG. 3 is a process flow diagram of a method embodiment under the present disclosure;

FIG. 4 is a process flow diagram of a method embodiment under the present disclosure;

FIG. 5 is a diagram of a user equipment embodiment under the present disclosure;

FIG. 6 is a diagram of a network node embodiment under the present disclosure;

FIG. 7 is a diagram of a telecommunication system embodiment under the present disclosure; and

FIG. 8 is a process flow diagram of a method embodiment under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claims. In addition, the terminology used herein is for the purpose of describing the embodiments and is not necessarily intended to limit the scope of the claims.

Passive intermodulation (PIM) distortion can impede the communications abilities of radio units, such as base stations, user devices, satellites, or any other radio device. PIM in a radio with multiple branches can be somewhat mitigated with prior art solutions such as receiver algorithms and PIM cancellation. Receiver algorithms include interference rejection combining (IRC) algorithms. IRC algorithms improve uplink performance in the presence of interference such as intercell interference. IRC algorithms can also mitigate PIM, however this means that the mitigation of intercell interference will degrade (i.e. PIM will require some of the degrees of freedom from the IRC algorithm). PIM cancellation is another technique that can mitigate PIM from the uplink signal in a radio. However, in some cases, the residual PIM that exists after PIM cancellation is large enough to impact UL performance. The implementation cost of PIM cancellation can also be prohibitive for radios with large antenna arrays.

Embodiments under the present disclosure mitigate PIM by turning off/down the power in at least one downlink carrier on at least one antenna branch. Embodiments can prevent PIM from being generated by sacrificing some downlink power. For a 32-branch radio with two downlink carriers, this could correspond to reducing the power by less than 0.1 dB in some instances.

Solutions under the present disclosure have numerous embodiments over the prior art. The described embodiments do not sacrifice uplink performance to mitigate PIM and are not limited by the behavior of the PIM source. Additionally, they are applicable to any intermodulation order, applicable to any level of PIM magnitude, and applicable to any time varying behavior of the PIM sources. They can be used simultaneously with other PIM mitigation solutions and have minor impact on the downlink performance when used in large antenna arrays.

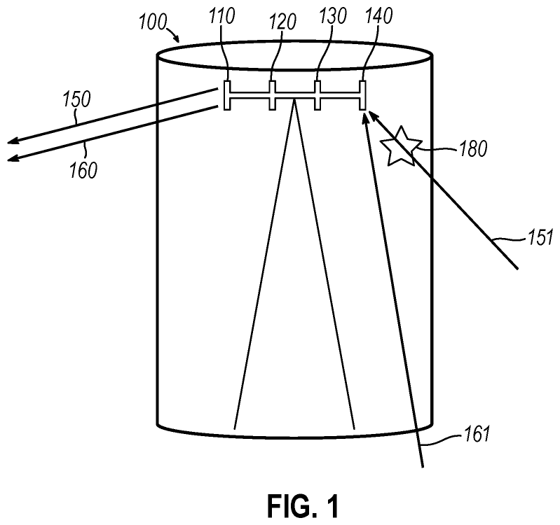

FIG. 1 shows a possible radio unit embodiment under the present disclosure. In this embodiment, a base station in a cellular network comprises a radio unit 100. Radio unit 100 comprises four antennas 110, 120, 130, 140. These can also be referred to as “antenna branches.” Any specific radio unit 100 could comprise more or fewer antennas or antenna branches. In this embodiment each antenna 110, 120, 130, 140 can utilize two different downlink carriers located at different frequencies, 150 and 160, as well as two uplink channels 151 and 161, located at different frequencies. While two FDD frequency pairs (150-160, 151-161) are shown in this embodiment, other radio unit and antenna embodiments may function with more or fewer carriers. During operation, radio unit 100 may experience PIM in one or more of the antennas 110, 120, 130, 140, in one or more of the uplink channels 151, 161. For illustrative purposes only, FIG. 1 shows PIM 180 occurring on antenna 140 in the uplink channel 151. As described further herein, embodiments under the present disclosure include techniques for identifying where PIM 180 is occurring, and taking counter-measures, such as lowering power on the subject antenna 140, one of the downlink frequency 150 or 160, thus mitigating the effects of PIM 180 while maintaining the functionality of the radio unit 100.

Various embodiments under the present disclosure can be used for an FDD (frequency division duplexing) AAS (advanced antenna systems) radio. This can refer to a base station radio that typically has more than 8 antenna branches, but other base station, radio units, and devices are contemplated under this disclosure. Other applications can include: non-AAS FDD radio, TDD (time division duplexing) radio with multiple TDD configurations (such as a dual-band TDD radio where the carrier in one band uses a different DL-UL (downlink uplink) pattern than the carrier in the other band), and others.

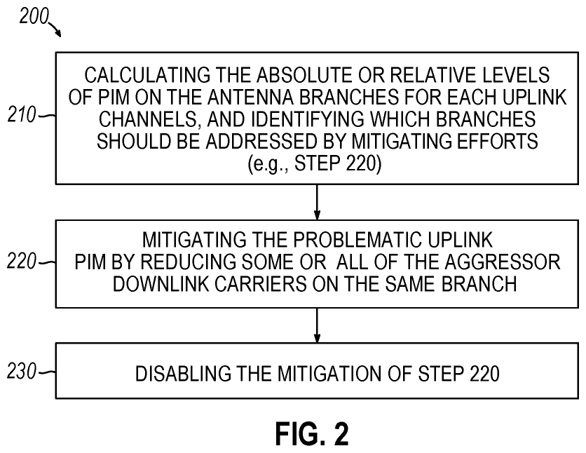

FIG. 2 displays one possible method embodiment 200 under the present disclosure. Step 210 is calculating the absolute or relative levels of PIM in the uplink channels for the various antenna branches and/or identifying which branches should be addressed by mitigation efforts, such as in Step 220. Step 220 is mitigating the problematic uplink PIM, e.g., by reducing some or all of the associated aggressor downlink carriers on the same branch. Step 230 is disabling the mitigation of step 220. Each step of this method can be performed in various ways as further described below.

In the context of the present disclosure, the associated downlink carrier(s) refer to the downlink signal(s) are that involved in creating the PIM problem that is occurring in certain uplink channel(s).

Step 210 of FIG. 2 is calculating the absolute or relative levels of PIM in the uplink channels for the multiple antenna branches and/or identifying which branches to perform mitigation measures on.

One embodiment of this step is to simultaneously perform UL measurements on multiple branches—for each uplink channel—and then compare the UL measurements between the branches. In an FDD AAS radio, strong inline PIM can cause the UL power in the branches affected by PIM to be significantly higher than the UL power in the branches not affected by PIM. For example, the UL power can be measured on multiple branches simultaneously. The branch with the highest power level can be chosen and compared against the next highest power branch measurement. Alternatively, the branch with the highest power level may be compared to the average power level across all branches. If the two values differ by more than some threshold (e.g., 0.1 dB, 1 dB, or another value depending on the embodiment and user needs), then the high UL power measurement would be identified as a branch to be addressed by mitigation steps, such as in FIG. 2 step 220.

This example could be modified to detect multiple branches with inline PIM so that mitigation is performed on multiple branches. The branch with the highest power level can be compared against the third highest branch power measurement. These two measurements would be used with a threshold to determine whether the branch with the highest power level should be addressed by mitigation steps. Then the branch with the second highest power level can be compared against the third highest power measurement. These two measurements would be used with a threshold (same or different from the threshold used with the highest measurement branch) to determine whether the branch with the second highest power level should be addressed by mitigation steps.

In some embodiments, UL power measurements could be made in a time domain for the multiple branches over some specified duration. A smaller duration can reduce the time it takes to identify which branches should be addressed by mitigation steps. A smaller duration will increase the variance of the measurement, which will result in a higher probability of false detection.

In some embodiments, an UL measurement could correspond to other metrics that are taken for each antenna branch. Examples are UL RSSI (received signal strength indicator), or UL interference, and noise measurements. There can be some additional latency associated with these types of measurements in comparison to time domain measurements. An advantage is that these measurements are already available, and some can isolate the power that is made up from all signals that are not the desired UL signal.

To address possible errors, imprecision, or PIM intermittence issues in the measurements, a simultaneous measurement and comparison can be repeated more than once. Basing a decision on multiple noisy measurements can reduce the probability of false detection. Using multiple measurements can come with an increase in delay in determining which branch(es) should be addressed by mitigation steps. Various methods for incorporating multiple measurements are contemplated under the present disclosure, so that proper mitigation steps are implemented.

In one example, the radio unit could make N measurements (e.g., of UL power). If the proportion of the measurements exceed some threshold value, then mitigation steps could be applied to the identified branch. For example, if N=10, then 10 measurements can be made of a given antenna or antenna branch. A threshold value could be e.g., 0.5 dB, or 0.1 dB above a comparison level. If, e.g., 5 of the 10 measurements are above the threshold value, then the given antenna or antenna branch can be targeted for mitigation steps. After 10 measurements, in this example, another 10 measurements can be made, comparison made, and so forth. Alternatively, the system can always keep the last N measurements, and if for example 5 exceed the threshold, the subject antenna or antenna branch can be subject to mitigation.

It may be necessary to discard some UL measurements. Some reasons could be:
The UL power on multiple branches exceeds some UL power threshold. This could happen if there is strong interference that is not related to PIM. The number that is considered ‘multiple’ branches would exceed the maximum number of branches that should be addressed by mitigation. As an example, if mitigation steps are set up to handle a maximum of two branches, then if more than two branches exceed some threshold, then the measurements could be discarded.
A problem with the UL measurement was detected, such as an overflow of a digital representation of a number.
The state of some radio function was changed shortly before the measurement. Examples of states that change in the radio are: automatic gain control in the receiver, or some state change in the linearization in the transmitter, or other possible sources of transient signals in a radio that could influence the UL measurement.

Embodiments of the UL measurements have been described as simultaneous. However, embodiments under the present disclosure include situations where measurements are relatively close in time, even if not perfectly simultaneous, or at predefined time slots, or upon triggering events. The UL measurements do not strictly need to be simultaneous, but can be carried out in delayed, or roughly real time embodiments. Embodiments of the method of step 210 of FIG. 2 could be run continuously or non-continuously.

In continuous embodiments, the UL measurements may or may not be periodic. In the first example, the UL measurements can be continuously made, and the method can be run after a sufficient number of measurements are available. In the second example, the method can be run periodically. In this case, UL measurements can be made when the method is run, and are not made in between.

In non-continuous embodiments an event can trigger the measurement. For example, when a problem is detected, such as a change in an UL performance metric like total cell throughput, then a measurement can be made. In another example, at step 230 of FIG. 2, the cessation of the mitigation can be a trigger, or when determining whether the mitigation method in step 220 can be disabled.

Some of the embodiments above described how UL measurements can be used to identify which branch(es) should be addressed with mitigation (i.e., which branch(es) could have PIM in any of their uplink channels). But in other embodiments other PIM detection solution methods can be utilized. For example, IRC algorithms can be used to identify antenna branches in need of mitigation. In another example, PIM cancellation techniques can be used for the purpose of identifying antennas or antenna branches in need of mitigation. These PIM detection methods (such as IRC or PIM cancellation) may allow certain embodiments of the present disclosure to avoid UL measurements, while still identifying where mitigation is needed.

Step 220 of FIG. 2 is mitigating the problematic uplink PIM, for example by reducing some or all of the aggressor downlink carriers on the same branch.

One embodiment of step 220 is to reduce power of at least one DL (downlink) carrier on the same branch to reduce the PIM level.
This reduction could be reducing the total carrier power, e.g., power related to the carrier related to the identified frequency. The amount of reduction could be based on the level of PIM, or on the impact of PIM. For example, the level of PIM could be estimated from step 210 from any measurements made, or are directly available from PIM detection methods (e.g., IRC or PIM cancellation).
The reduction could correspond to muting the DL carrier(s) associated, i.e., that are involved in creating the PIM problem that is monitored in the UL channel, with the identified uplink channel(s).
The reduction could involve blocking some data from being transmitted onto the carrier for the DL branch to be addressed. This data could correspond to the PDSCH (physical downlink shared channel) while still allowing signals needed for user devices to identify system information.

In other mitigation embodiments, when there are multiple frequencies (and likewise multiple carriers transmitting data) on a branch, then all frequencies can be reduced. It is also possible to reduce a subset of the frequencies on the branch. There are multiple embodiments for choosing which DL frequencies to reduce.

On a particular antenna or antenna branch some downlink carriers will have more of an impact than others on the level of PIM. As an example, for a branch with two DL carriers, the DL carrier that is closest to the impacted UL channel will have a larger impact on the PIM level. This type of relationship can be used to determine which DL carrier should be addressed by the proposed power reduction method.

When multiple branches are being addressed, then it could be advantageous to not mute the same DL carrier on all branches (i.e., spread the DL degradation across multiple carriers). For example, a specific carrier might at the 1700 Mhz band, and this frequency is the impacted UL channel. While the radio unit could choose to lower the power used at the 1700 Mhz band across all antennas, this might harm the downlink performance at this frequency. Instead, it might be preferred to solely reduce power at the 1700 Mhz band on only one or two antennas. The state of the carriers on other branches that are already reduced can be used in the decision to determine which DL carriers on another branch should be reduced. In addition, it is possible that at least one of the DL carrier should not be reduced (e.g., predetermined by the radio operator). This constraint would be used in determining which DL carriers should be power reduced.

In some embodiments, the PIM mitigation step 220 is enabled by the scheduler only when high pathloss users, also known as cell-edge users, are scheduled on the PIM impacted uplink frequency 151. The pathloss threshold that is used by the scheduler to trigger this operation may be configurable and may depend on the PIM levels. This may help reduce the DL network-level performance impact of the PIM mitigation solution described herein.

After performing the mitigation steps (such as step 220 of FIG. 2), it must be determined when to end the mitigation steps. This step, such as step 230 of FIG. 2, can comprise various approaches.

There are several reasons to disable the PIM mitigation from the previous step. For one thing, PIM is dynamic. The problem could come and go, so it would be advantageous to not permanently reduce some of the DL carriers on some branches. Another reason is that all detection algorithms have some finite probability of false alarm. This finite probability means that it is expected that in some cases that the mitigation steps (step 220 of FIG. 2) will be used to address a false alarm (from step 210). Further, it is possible that another type of problem could cause step 210 to identify a branch to be addressed by step 220, but this problem is not PIM related and is not mitigated with step 220. An example could be a faulty receiver branch.

One embodiment of step 230 of FIG. 2 is to disable the mitigation from step 220 after some period of time (e.g., 0.1 sec., 1 sec., 10 secs., or any appropriate duration). In this embodiment of step 230 we allow step 220 to reduce at least one DL carrier on the branch(es) that need to be addressed for the chosen time duration. After the period of time has elapsed, then the embodiments of step 210 will then call step 220 again if the problem persists.

In another embodiment of step 230, there can be a coordinated disabling of mitigation from step 220 with UL measurements from step 210. In this embodiment certain time slots can be used to temporarily disable the mitigation from step 220. This could correspond to one long time slot (long enough to allow step 210 to execute), or over discontinuous time slots (each allowing a single measurement in step 210). The mitigation is disabled if the results form step 210 show that the branch no longer needs to be addressed. The time slots could be chosen when there is expected to be minimal/acceptable impact on the UL. An example could be during a time duration when there are no UL resources scheduled.

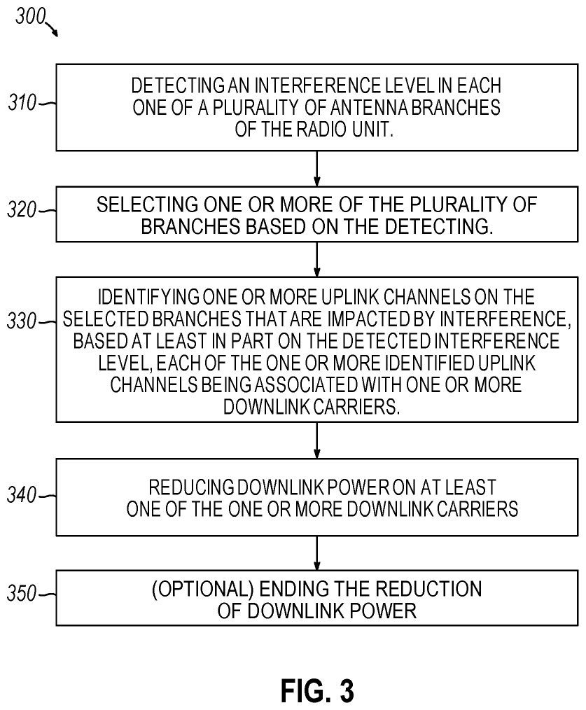

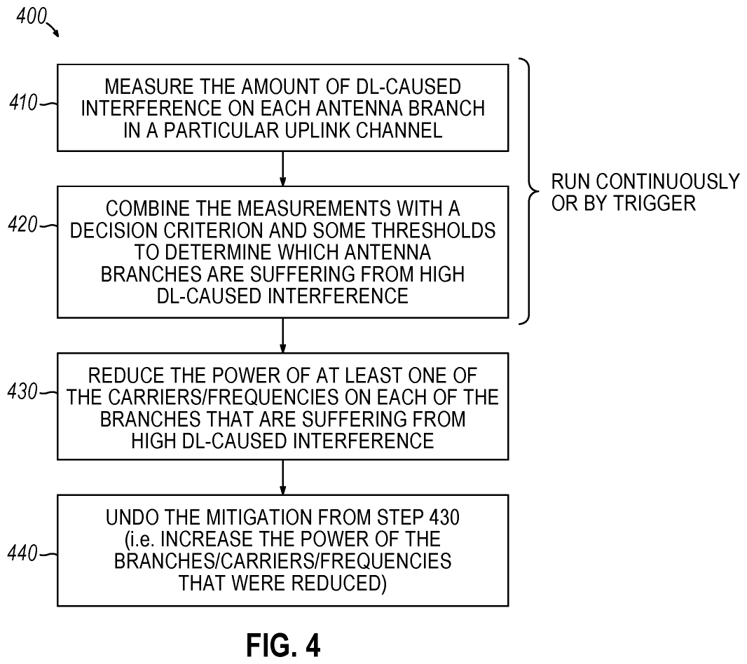

FIGS. 3 and 4 shows alternative embodiments under the present disclosure for identifying PIM and taking mitigation measures.

Method 300 comprises a method performed by a radio unit for mitigating interference in an uplink channel of the radio unit. Step 310 is detecting an interference level in each one of a plurality of antenna branches of the radio unit. Step 320 is selecting one or more of the plurality of branches based on the detecting. Step 330 is identifying one or more uplink channels on the selected branches that are impacted by interference, based at least in part on the detected interference level, each of the one or more identified uplink channels being associated with one or more downlink carriers. Step 340 is reducing downlink power on at least one of the one or more downlink carriers. And step 350 (optional) is ending the reduction of downlink power.

Method 400 is another method embodiment performed by a radio unit, such as a base station, for identifying and mitigating PIM. Step 410 is to measure the amount of DL-caused interference on each antenna branch in a particular uplink channel. Step 420 is to combine the measurements with a decision criterion and some thresholds to determined which antenna branches are suffering from high DL-caused interference. Steps 410 and 420 can be run continuously or upon triggering events, as described above. Step 430 is to reduce the power of at last one of the carriers/frequencies on each of the branches that are suffering from high DL-caused interference. Step 440 is to undo the mitigation from step 430 (i.e., increase the power for the branches/carriers/frequencies that were reduced).

The present disclosure has discussed the mitigation of interference problems related to PIM. However, the methods and systems discussed could be used to address other UL problems where the DL carriers in particular branches are the aggressors. For example, DL leakage caused by non-linear active electronic components on the radio Printed Circuit Boards (PCB). Another example would be DL leakage due to a non-linear power amplifier. This could be caused by some problems with the Digital Pre-Distortion (DPD) adaptation.

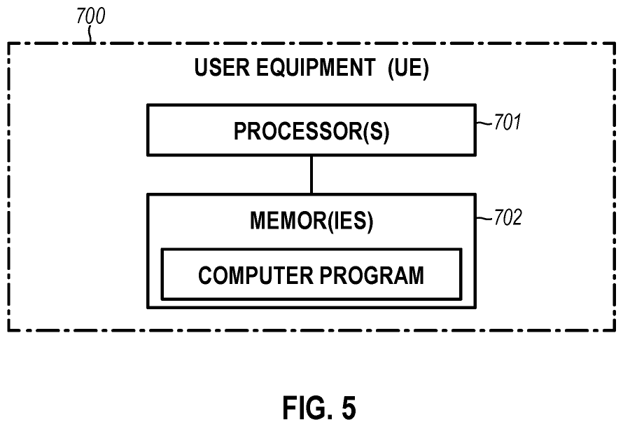

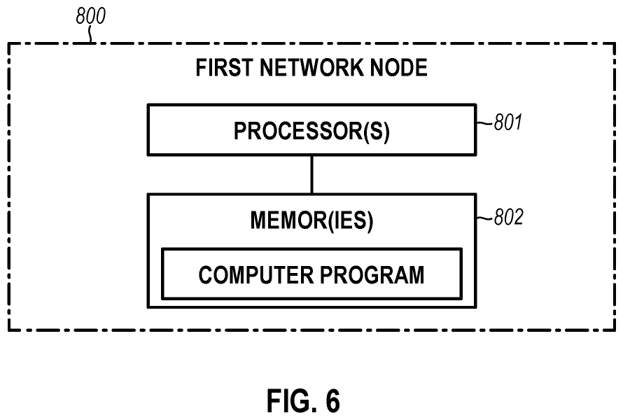

FIGS. 5-6 show schematic block diagrams of a UE 700 and a network node 800 according to embodiments of the present disclosure. Various types of UEs 700 and network nodes may comprise radio units, such as radio unit 100 of FIG. 1, that may take advantage of the embodiments under the present disclosure. The UE 700 may include at least a processor 701 and at least a memory 702. As shown in FIG. 5, the memory 702 has stored thereon a computer program which, when executed on the processor 701, causes the processor 701 to carry out any of the methods performed in a radio unit according to the present disclosure. As shown in FIG. 6, the memory 802 has stored thereon a computer program which, when executed on the processor 801, causes the processor 801 to carry out any of the methods performed in a radio unit according to the present disclosure. The memory 702/802 may be, e.g., an Electrically Erasable Programmable Read-Only Memory (EEPROM), a flash memory and a hard drive. The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules could in alternative embodiments be distributed on different computer program products in the form of memories within the UE or the network nodes.

In an embodiment of the present disclosure, there is provided a computer-readable storage medium having stored thereon a computer program which, when executed on at least one processor, causes the at least one processor to carry out any applicable method according to the present disclosure. Embodiments under the present disclosure can include systems and methods wherein a UE, such as described above, comprises a node in a mesh network.

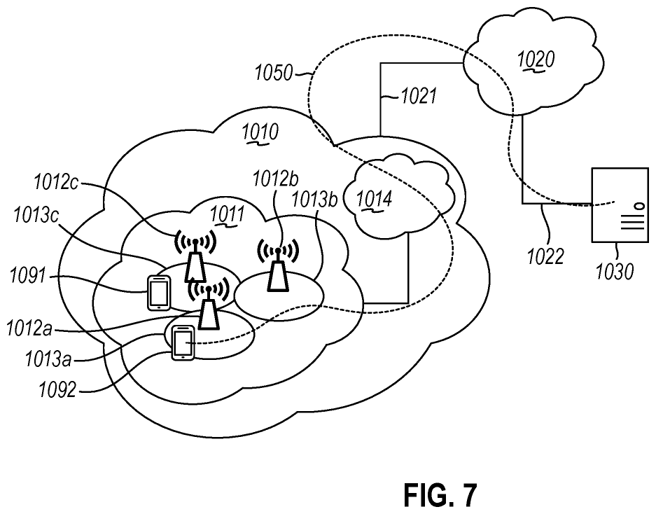

FIG. 7 schematically illustrates a telecommunication network connected via an intermediate network to a host computer. The base stations 1012a, 1012b, 1012c, preferably comprise a radio unit such as described with respect to FIG. 1, with the other capabilities described herein. With reference to FIG. 7, in accordance with an embodiment, a communication system includes a telecommunication network 1010, such as a 3GPP-type cellular network, which comprises an access network 1011, such as a radio access network, and a core network 1014. The access network 1011 comprises a plurality of base stations 1012a, 1012b, 1012c, such as NBs, eNBs, gNBs or other types of wireless access points, each defining a corresponding coverage area 1013a, 1013b, 1013c. Each base station 1012a, 1012b, 1012c is connectable to the core network 1014 over a wired or wireless connection 1015. A first user equipment (UE) 1091 located in coverage area 1013c is configured to wirelessly connect to, or be paged by, the corresponding base station 1012c. A second UE 1092 in coverage area 1013a is wirelessly connectable to the corresponding base station 1012a. While a plurality of UEs 1091, 1092 are illustrated in this example, the disclosed embodiments are equally applicable to a situation where a sole UE is in the coverage area or where a sole UE is connecting to the corresponding base station 1012.

The telecommunication network 1010 is itself connected to a host computer 1030, which may be embodied in the hardware and/or software of a standalone server, a cloud-implemented server, a distributed server or as processing resources in a server farm. The host computer 1030 may be under the ownership or control of a service provider, or may be operated by the service provider or on behalf of the service provider. The connections 1021, 1022 between the telecommunication network 1010 and the host computer 1030 may extend directly from the core network 1014 to the host computer 1030 or may go via an optional intermediate network 1020. The intermediate network 1020 may be one of, or a combination of more than one of, a public, private or hosted network; the intermediate network 1020, if any, may be a backbone network or the Internet; in particular, the intermediate network 1020 may comprise two or more sub-networks (not shown).

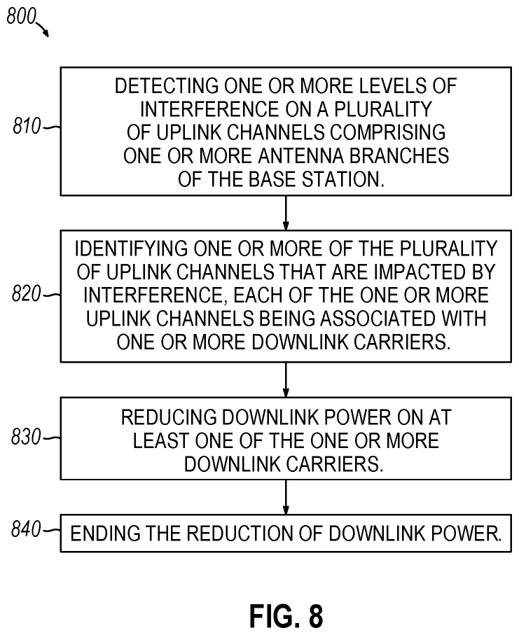

Reference has been made in describing some embodiments to PIM. But embodiments under the present disclosure can be used to mitigate various types of interference. The identification of antenna branches and channels/frequencies suffering interference can be performed in similar ways to the identification of PIM as described herein. For example, method 800 shown in FIG. 8, can be used to identify and mitigate interference within a radio unit. Step 810 is detecting one or more levels of interference on a plurality of uplink channels comprising one or more antenna branches of the base station. Step 820 is identifying one or more of the plurality of uplink channels that are impacted by interference, each of the one or more uplink channels being associated with one or more downlink carriers. Step 830 is reducing downlink power on at least one of the one or more downlink carriers. Step 840, optional, is ending the reduction of downlink power.

### Computer Systems of the Present Disclosure

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The memory may take any form and may depend on the nature and form of the computing system. The memory can be physical system memory, which includes volatile memory, non-volatile memory, or some combination of the two. The term “memory” may also be used herein to refer to non-volatile mass storage such as physical storage media.

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof.

For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The term “executable component” is also well understood by one of ordinary skill as including structures that are implemented exclusively or near-exclusively in hardware logic components, such as within a field programmable gate array (FPGA), an application specific integrated circuit (ASIC), Program-specific Standard Products (ASSPs), System-on-a-chip systems (SOCs), Complex Programmable Logic Devices (CPLDs), or any other specialized circuit. Accordingly, the term “executable component” is a term for a structure that is well understood by those of ordinary skill in the art of computing, whether implemented in software, hardware, or a combination thereof.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

Accordingly, embodiments described herein may comprise or utilize a special purpose or general-purpose computing system. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example—not limitation-embodiments disclosed or envisioned herein can comprise at least two distinctly different kinds of computer-readable media: storage media and transmission media.

Computer-readable storage media include RAM, ROM, EEPROM, solid state drives (“SSDs”), flash memory, phase-change memory (“PCM”), CD-ROM or other optical disk storage, magnetic disk storage or other magnetic storage devices, or any other physical and tangible storage medium that can be used to store desired program code in the form of computer-executable instructions or data structures and that can be accessed and executed by a general purpose or special purpose computing system to implement the disclosed functionality of the disclosure. For example, computer-executable instructions may be embodied on one or more computer-readable storage media to form a computer program product.

Transmission media can include a network and/or data links that can be used to carry desired program code in the form of computer-executable instructions or data structures and that can be accessed and executed by a general purpose or special purpose computing system. Combinations of the above should also be included within the scope of computer-readable media.

Further, upon reaching various computing system components, program code in the form of computer-executable instructions or data structures can be transferred automatically from transmission media to storage media (or vice versa). For example, computer-executable instructions or data structures received over a network or data link can be buffered in RAM within a network interface module (e.g., a “NIC”) and then eventually transferred to computing system RAM and/or to less volatile storage media at a computing system. Thus, it should be understood that storage media can be included in computing system components that also—or even primarily—utilize transmission media.

Those skilled in the art will further appreciate that a computing system may also contain communication channels that allow the computing system to communicate with other computing systems over, for example, a network. Accordingly, the methods described herein may be practiced in network computing environments with many types of computing systems and computing system configurations. The disclosed methods may also be practiced in distributed system environments where local and/or remote computing systems, which are linked through a network (either by hardwired data links, wireless data links, or by a combination of hardwired and wireless data links), both perform tasks. In a distributed system environment, the processing, memory, and/or storage capability may be distributed as well.

Those skilled in the art will also appreciate that the disclosed methods may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

### ABBREVIATIONS AND DEFINED TERMS

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure includes a specific reference to one or more embodiments thereof, and vice versa, and is intended to provide illustrative examples without limiting the scope of the disclosure, which is indicated by the appended claims rather than by the following description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

As used herein, directional terms, such as “top,” “bottom,” “left,” “right,” “up,” “down,” “upper,” “lower,” “proximal,” “distal,” “adjacent,” and the like are used herein solely to indicate relative directions and are not otherwise intended to limit the scope of the disclosure and/or claims.

### CONCLUSION

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the disclosure. Thus, it should be understood that although the present disclosure has been specifically described in part by preferred embodiments, exemplary embodiments, and optional features, modification and variation of the concepts herein disclosed may be resorted to by those skilled in the art, and such modifications and variations are considered to be within the scope of this disclosure as defined by the appended claims. The specific embodiments provided herein are examples of useful embodiments of the present disclosure and various alterations and/or modifications of the inventive features illustrated herein, and additional applications of the principles illustrated herein that would occur to one skilled in the relevant art and having possession of this disclosure, can be made to the illustrated embodiments without departing from the spirit and scope of the disclosure as defined by the claims and are to be considered within the scope of this disclosure.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

All references cited in this application are hereby incorporated in their entireties by reference to the extent that they are not inconsistent with the disclosure in this application. It will be apparent to one of ordinary skill in the art that methods, devices, device elements, materials, procedures, and techniques other than those specifically described herein can be applied to the practice of the invention as broadly described herein without resort to undue experimentation. All art-known functional equivalents of methods, devices, device elements, materials, procedures, and techniques specifically described herein are intended to be encompassed by this disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. All changes which come within the meaning and range of equivalency of the claims are to be embraced within their scope.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method performed by a radio unit for mitigating interference in an uplink channel of the radio unit, the method comprising:
detecting an interference level in each one of a plurality of antenna branches of the radio unit;
selecting one or more of the plurality of branches based on the detecting;
identifying one or more uplink channels on the selected branches that are impacted by interference, based at least in part on the detected interference level, each of the one or more identified uplink channels being associated with one or more downlink carriers; and
reducing downlink power on at least one of the one or more downlink carriers.

2. The method of claim 1 wherein the detected interference level in each one of a plurality of antenna branches comprises passive intermodulation (PIM) distortion.

3. The method of claim 1 wherein the detecting comprises measuring uplink power in at least one uplink channel on the plurality of antenna branches.

4. The method of claim 1 wherein selecting comprises detecting a difference between a highest power branch and an average of the plurality of antenna branches, and selecting the highest power branch if the detected difference is greater than a threshold value.

5. The method of claim 1 wherein selecting comprises detecting a difference between a highest power branch and a second highest power branch, and selecting the highest power branch if the detected difference is greater than a threshold value.

6. The method of claim 1 wherein selecting comprises detecting a difference between a highest power branch and a third highest power branch, and selecting the highest power branch if the detected difference is greater than a threshold value.

7. The method of claim 6 further comprising detecting a second difference between a second highest power branch and a third highest power branch, and selecting the second highest power branch if the second detected difference is greater than the threshold value.

8. The method of claim 1 wherein detecting the interference level comprises measuring at least one of: uplink received signal strength indicator, uplink interference, and noise.

9. The method of claim 3 wherein measuring uplink power comprises making a plurality of measurements.

10. The method of claim 9 wherein selecting one or more of the plurality of branches comprises selecting a branch if a predetermined proportion of the plurality of measurements of the branch are above a preselected value.

11. (canceled)

12. The method of claim 1 wherein if the number of selected branches is more than a preset value, then at least one of the selected branches is deselected.

13. The method of claim 1 wherein the detecting is performed on the plurality of branches simultaneously.

14. The method of claim 1 wherein the detecting is performed by one of the following methods: continuously, repeatedly at preset time intervals, and upon a triggering event.

15. (canceled)

16. (canceled)

17. (canceled)

18. (canceled)

19. The method of claim 1 wherein the detecting comprises inputs from an interference rejection combining algorithm.

20. The method of claim 1 wherein the detecting comprises inputs from a PIM cancellation technique.

21. The method of claim 1 wherein the reducing comprises reducing the downlink power of at least one downlink carrier in one or more selected branches.

22. The method of claim 1 wherein the reducing comprises blocking data from being transmitted in at least one downlink carrier.

23. (canceled)

24. (canceled)

25. The method of claim 1 wherein the reducing is enabled by the scheduler only when high pathloss users are scheduled in the uplink.

26. (canceled)

27. The method of claim 1 wherein the reducing comprises preventing reduction of power on any of the one or more downlink carriers associated with a specific one of the one or more uplink channels.

28. (canceled)

29. (canceled)

30. (canceled)

31. A first network node, comprising,
a processor; and
a memory having stored thereon a computer program which, when executed on the processor, causes the processor to carry out the method according claim 1.

32. (canceled)
